(19) United States
(12) Patent Application Publication
(10) Pub. No.: US 2015/0350229 A1
(43) Pub. Date: Dec. 3, 2015

(54) Network Threat Detection and Mitigation Using a Domain Name Service and Network Transaction Data

(71) Applicant: Singularity Networks, Inc., Highlands Ranch, CO (US)

(72) Inventor: David James Mitchell, Highlands Ranch, CO (US)

(21) Appl. No.: 14/802,204

(22) Filed: Jul. 17, 2015

Related U.S. Application Data
(63) Continuation-in-part of application No. 14/502,639, filed on Sep. 30, 2014.
Application No. 14/502,639 is a continuation of application No. 14/290,611, filed on May 29, 2014, now Pat. No. 8,881,281.

(51) Int. Cl. H04L 29/06; H04L 29/08; H04L 12/26; G06F 17/30

(52) U.S. Cl. CPC H04L 63/1416; G06F 17/30876; H04L 67/10; H04L 43/16

(57) ABSTRACT

In an embodiment, a method detects an abuse to a network environment. In the method, real-time name service transaction data to resolve a domain name to a network address is collected from the network environment. Historical name service information for the domain name is retrieved. Transaction information describing data sent between the network environment and the network address is collected. The collected transaction information and the historical name service information is analyzed against at least one rule. When the collected transaction information and the historical name service information are determined to match at least one rule, the network address is determined to be is associated with a potential abuser of the network environment.

This application is a continuation-in-part of U.S. patent application Ser. No. 14/502,639, filed Sep. 30, 2014, which is a continuation of U.S. patent application Ser. No. 14/290,611, filed May 29, 2014, now U.S. Pat. No. 8,881,281, both of which are incorporated by reference in their entirety.

### BACKGROUND

1. Field

This field is generally related to network security.

2. Related Art

A communication network may, for example, allow data to be transferred between two geographically remote locations. To transmit data over a network, the data is often divided into pieces, known as packets or blocks. Each packet or block may have a destination network address, such as IP address, that indicates a destination of the packet and intermediate forwarding devices where the packet should be routed. These addresses are often numerical, difficult to remember, and may frequently change.

To identify a destination, a fully qualified domain name is frequently used. An FQDN identifies a destination host, or server, and may map to a corresponding network address. For example, the domain name www.example.com may map to the network address 93.184.216.119. To map the domain names to the network addresses, a domain name system (DNS) may be used. A FQDN can only resolved by the DNS Name Server Resource Record (DNS NS RR) authorized by the registration assigned within the DNS Top Level Domain (DNS TLD) information.

DNS serves as the phone book for the Internet by translating human-friendly computer hostnames into IP addresses. It is a hierarchical distributed naming system for computers, services, or any resource connected to the Internet or a private network. Being hierarchical, it distributes the responsibility of assigning domain names and mapping those names to IP addresses by designating authoritative name servers for each domain.

Networks are used, for example, to provide applications, such as web and other IP enabled applications, to users. Typically, these applications operate by receiving a request, such as a Hypertext Transfer Protocol (HTTP) request, and, based on the request, supplying a response. The request and response may be formatted in accordance with a known application program interface (API). The requests are generally transmitted via a public or private network, such as the Internet or an internal network, to the service provider. The service provider has its own environment that services the request. The environment may include a plurality of different devices that coordinate with each other to provide the service. The devices may coordinate over a private network belonging to the service provider. Or, the devices may operate in a cloud or a public network.

Not all application and network requests are legitimate. Sometimes, these requests are meant to abuse the network or the application. Abuse can come in several forms. For example, some abuse mechanisms try to overwhelm a service so that it cannot service legitimate requests. These are referred to as denial of service requests, whether at the network or application layer. One common mechanism of abuse is referred to as application abuse. An example of this is a malicious entity fraudulently creating accounts on an application platform and subsequently transporting illegitimate traffic through the network environment.

Another type of denial of service abuse is a Transport Control Protocol (TCP) SYN flood abuse. Normally when a client attempts to start a TCP connection to a server, the client requests a connection by sending a SYN (synchronize) message to the server, the server acknowledges this request by sending SYN-ACK back to the client, and the client responds with an ACK. A SYN flood abuse works by not responding to the server with the expected ACK code, failing to finish the transaction. Enough of these unfinished transactions can overwhelm a server, rendering it unable to respond to additional requests.

Other abuses may not be trying to bring down a service, but may instead be making requests for other improper purposes. In these abuses, an automated system may be making application requests that, for example, set up fake user accounts and try to entice a user to devolve confidential information, such as her password, credit card information, or Social Security number, or run other personally identifiable information. These abuses are sometimes referred to as application or application abuse. Often times, these abuse vectors can be concealed inside of an encrypted transport method, such as SSL (Secure Sockets Layer) or IPSec (Internet Protocol Security).

Hardware appliances are available that try to control these type of network and application abuses. Some of these appliances may, for example, operate by maintaining a database of fingerprints of known threats. A database of known threats may be generated by human analysts and include fingerprints identifying different potential threats. As the appliance manufacturer becomes aware of new threats, it may send updates to the database. Using the database, the appliance scans for potential threats.

New systems and methods are needed to better protect against these abuses.

### BRIEF SUMMARY

In an embodiment, a method detects an abuse to a network environment. In the method, real-time name service transaction data to resolve a domain name to a network address is collected from the network environment. Historical name service information for the domain name is retrieved. Transaction information describing data sent between the network environment and the network address is collected. The collected transaction information and the historical name service information is analyzed against at least one rule. When the collected transaction information and the historical name service information are determined to match at least one rule, the network address is determined to be is associated with a potential abuser of the network environment.

System and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating a system for abuse detection and mitigation using DNS and network transaction data, according to an embodiment.

FIG. 2 is a diagram illustrating components of a threat detection device in FIG. 1 in greater detail, according to an embodiment.

FIG. 3 is a diagram illustrating components of the system in FIG. 1

FIG. 4 is a flowchart illustrating a method for abuse detection, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

To detect potential threats, embodiments use both the network transaction data and name service transaction data together. This may result in improved accuracy and may detect potential threats that would otherwise be missed. While DNS is used for illustrative purposes, a skilled artisan would recognize aspects would apply to other name services as well.

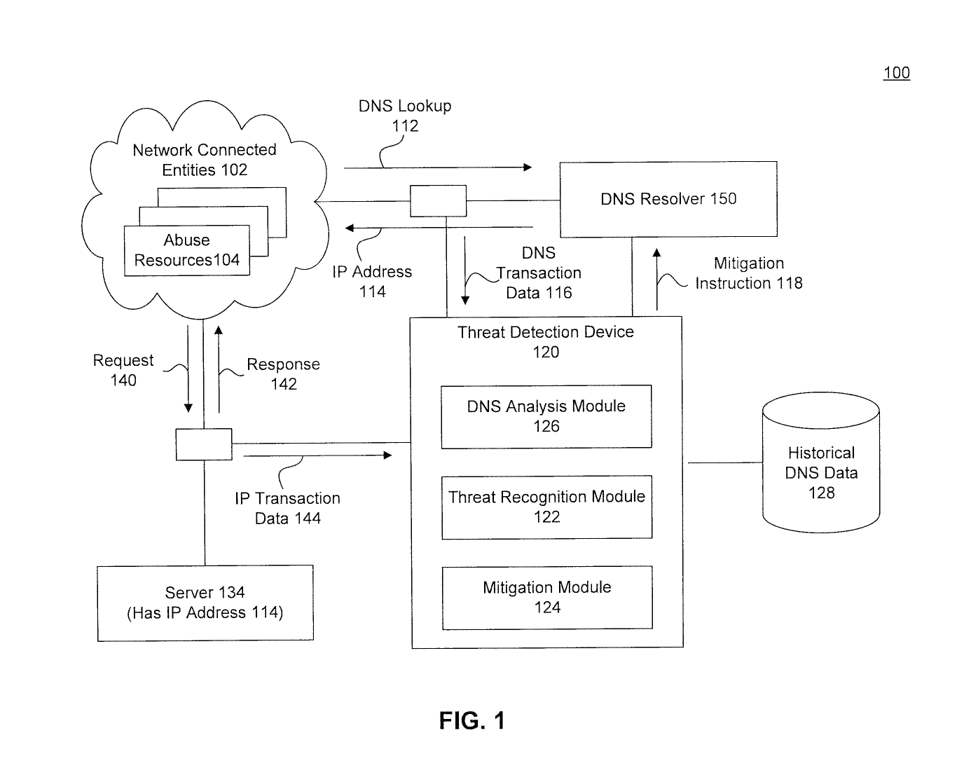

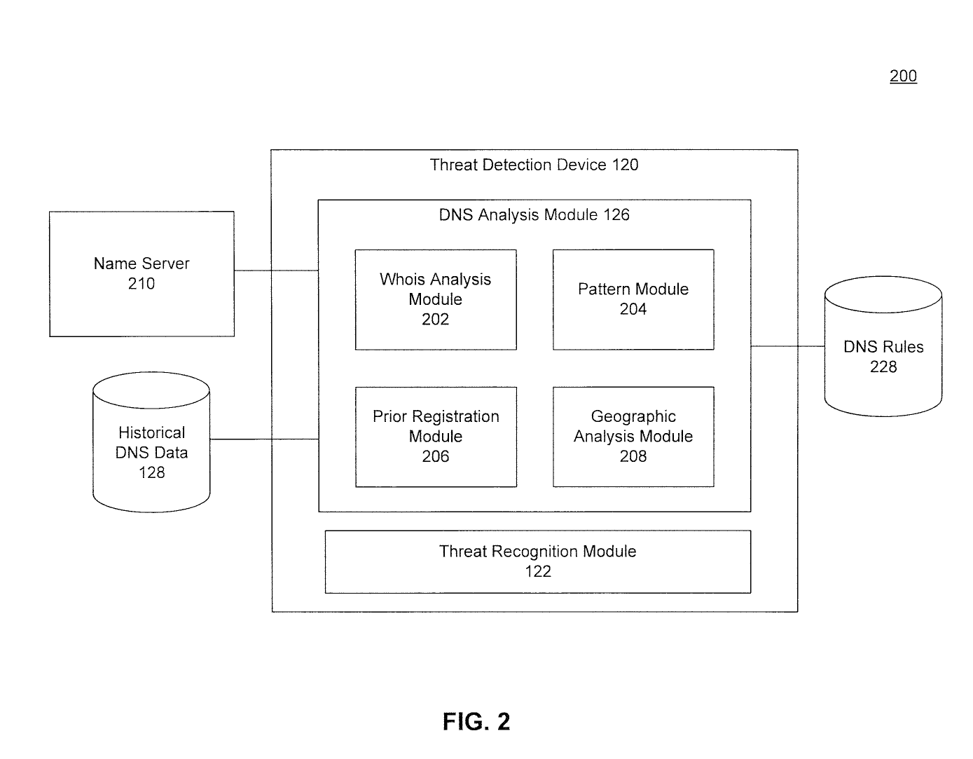

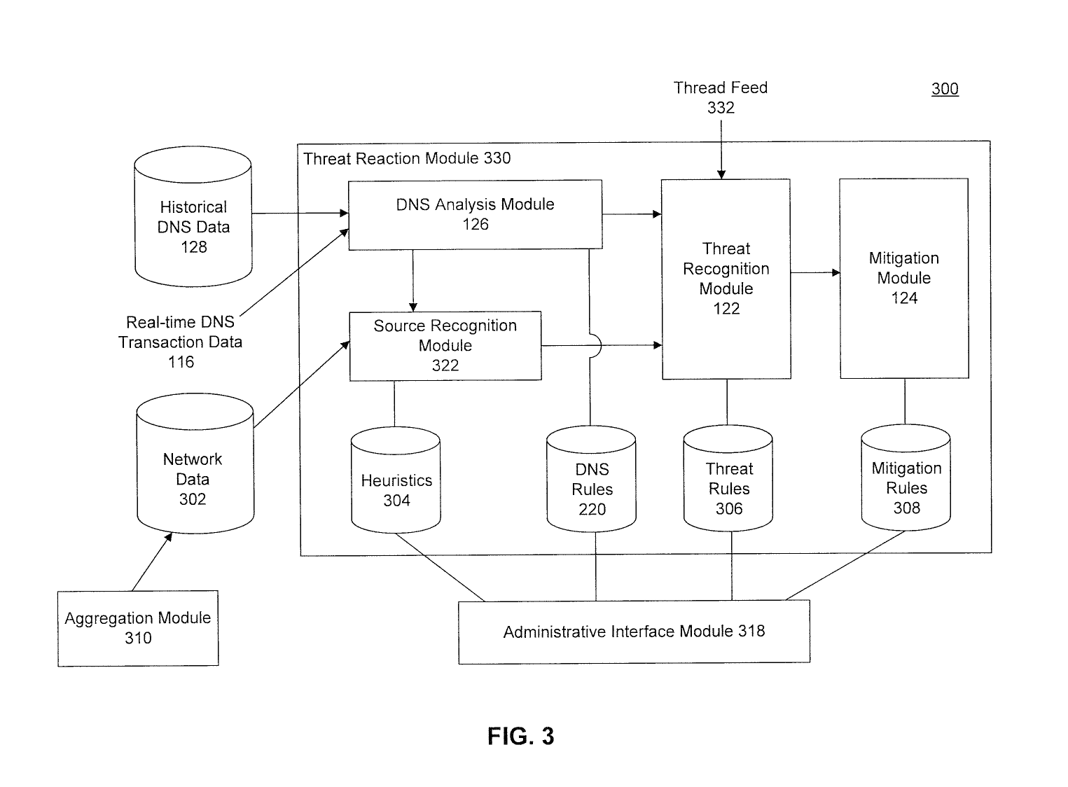

FIG. 1 is a diagram illustrating a system 100 for abuse detection and mitigation using DNS and network transaction data, according to an embodiment. FIG. 1 is a diagram illustrating a system 100 for abuse detection and mitigation, according to an embodiment. System 100 includes one or more network connected entities 102, such as the Internet, a DNS resolver 144, a server 134 and a threat detection device 120. Each of these components is described below, and in more detail with respect to FIGS. 2 and 3.

Network connected entities 102 includes a plurality of abuse resources 104. Abuse resources 104 may be a number of different devices with different identities. For example, abuse resources 104 may be addressable on network connected entities 102 by differing Internet Protocol (IP) addresses or other resource identifiers, such as HTTP User-Agents, DNS Resource Record data, IP routing information, reputation data, Whois information such as hosting provider, names, telephone numbers, locations & street addresses, etc.

Abuse resources 104 may be computers of or controlled by a malicious person, such as a malicious entity. For example, they may be computing devices that the abuse resource owns, or at least partially controls, for the purpose of enacting harm upon the network environment or users thereof. The malicious entity can highjack devices 104 to take part in an abuse by installing a virus or malware. For example, in the SYN abuse described above, the malicious entity can engage a number of different devices 104 to initiate uncompleted TCP sessions by infecting the devices with malware. Or, the malicious entity can engage devices 104 to take part in the abuse using their own call-response protocol. For example, the malicious entity can engage devices 104 to take part in the abuse by sending messages with a fraudulent return address, prompting the devices to reply to the fraudulent return address, which can overwhelm it.

To engage in attack, abuse resources 104 may look up a domain name to determine a network address. To look up a domain name, abuse resources 104 may send a DNS lookup 112 to a DNS resolver 144. DNS lookup 112 may be a request formatted according to a DNS format that includes the hostname queried.

While DNS resolver 144 is shown separate from abuse resources 104 for clarity, DNS resolver 144 may, in fact, be implemented on an abuse resource 104. DNS resolver 144 is responsible for initiating and sequencing queries to DNS name servers that ultimately lead to a full resolution, or translation, of a domain name into a network address, such as an IP address. The sequence of queries to resolve www.example.com may, for example, start at the root name server, which indicates the address of the name server for .com. Then, DNS resolver 144 may query the name server for .com for the address of the name server for example.com. Then, DNS resolver 144 may query the name server for example.com for the address of www.example.com. In practice. so that DNS resolver 144 does not need to go through the entire sequence for each request, DNS resolver 144 may cache the addresses of the various name servers. In addition, DNS caching servers may be used so that the name server does not need to answer every query.

After determining the network address, DNS resolver 144 returns the IP address to abuse resources 104 to IP address 114. The DNS lookup 112 and resulting IP address 114 are DNS transaction data, referenced in the drawings as DNS transaction data 116.

After determining IP address 114, abuse resource 104 may use the IP address to further an attack. In particular, abuse resource 104 may send a request 140 the server having IP address 114, illustrated in FIG. 1 as server 134. In response, server 134 may send a response 142 back to abuse resource 104 to further the attack. As with previously obtained DNS transaction data 116, threat detection device 120 may collect IP transaction data 144.

IP transaction data 144 could include netflow data, packet capture (PCAP) data, sFlow data, or application level request data. Each is addressed in turn.

Netflow data, as the term is used herein, is not limited to data from a particular brand or type of router. The netflow data may include a record for each data flow. Each data flow may be one or more packets in time proximity with one another having a common protocol identified via Internet Protocol (IP) addresses and Transport Control Protocol (TCP) or User Datagram Protocol (UDP) ports. When a certain amount of time passes after receipt of a packet having these characteristics, the network device determines that the flow has ended, and if the network device receives any additional packets with these characteristics, the network device regards the packets as belonging to a new data flow and represents them with a new netflow data record. Each netflow record may include the data flow's (1) source and destination IP address, (2) source port and destination UDP or TCP port, (3) type of protocol, (4) start and end times, and (5) size (e.g., number of bytes). In this way, netflow data summarizes certain characteristics of a data flow.

Unlike this summary netflow information, packet inspection or packet capture (PCAP) data can capture an entire packet, and/or create a record of the details of an application or data flow. This may be useful for inspecting the body and payload of a packet and its contents. Network connected entities 102 may have operating system interfaces that enable this feature. Collecting all packets in this method may be too costly on network and computing resources thus, threat detection device 120 may sample this data, perhaps only capturing the first packet, or first several packets, in each data flow.

The application layer data may include data in the application requests. In the social media service example above, if the application requests are to create new user accounts, the data collected may include the desired user name, password, user-agent, timestamp and source IP address. If the application request is to post new data to the user's account or to another user's account, threat detection device 120 may collect the data sought to be posted. Further, in the embodiments, data can be obtained from application and IT infrastructure monitoring or security solutions including logging of various types, syslog, SIEM logs, Firewall logs, Application Server Load Balancers (SLBs), application and programming code management and performance monitoring systems instrumentation and output, and others which could singularly or collectively, provide intelligence data to identify abuse in a network environment(s).

To collect the DNS transaction data 116 and IP transaction data 144, threat detection device 120 may, for example, use a listening module (not shown) installed on the source or destination devices or on intermediate devices connecting the source and destination. The listening module may collect the transaction data and transmit it to threat detection device 120. In addition to gathering all transaction data, the listening software may be configured to collect only a subset of the transaction data, for example meeting a criteria, and only send on that subset. In different embodiments, the listening module may also compress the transaction data, for example by aggregating and duplicating the data, before forwarding it on to threat detection device 120.

Having received DNS and IP transaction data 116 and 144, threat detection device 120 uses the data to determine whether an attack may be in progress or imminent. As shown in FIG. 1, threat detection device 120 includes three modules: a DNS analysis module 126, a threat recognition module 122 and a mitigation module 124.

DNS analysis module 126 retrieves historical name service information for the domain name or IP address and analyzes the collected DNS transaction data 116 and historical DNS data 128 against at least one rule. As described in more detail below, the rules may look for patterns in the DNS registration or evaluate Whois information from the DNS system. They may evaluate the DNS data over time, for example, by comparing to prior registration data for the domain or checking to see if the domain changes frequently. It may also consider geographic information associated with the device to evaluate the suspiciousness of a domain or address. Further discussion of the operation of DNS analysis module 126 is described below with respect to FIG. 2.

Threat recognition module 122 evaluates network data 144 and information from DNS analysis module 126 determine whether the common abuse entity is a potential malicious entity of the network environment. To determine whether the common abuse entity is a potential malicious entity, threat recognition module 122 can use threat rules. Threat rules may specify conditions where the threat recognition module 122 identifies a source as a malicious entity. The conditions may be based on a variety of inputs, including a rate, an external threat feed, and others.

If threat detection device 120 determines that the common abuse entity controlling abuse resources 104 is engaged in a potential abuse, mitigation module 124 determines what, if anything, should be to mitigate it. Mitigation module 124 may specify any mitigation actions on mitigation instructions 118 and send mitigation instructions 118 to an attack mitigation device (not shown). The attack mitigation device may, for example, be a commonly available or specialized firewall, router, switch, load balancer, DNS server, distributed denial of service (DDOS) mitigation appliance or other devices to mitigate the abuse. When the attack mitigation device receives mitigation instructions 118, it takes action to mitigate the abuse. This may mean blocking certain traffic, such as traffic having certain source IP addresses or DNS records, or marking certain user accounts as suspect due to anomalous application behavior or threat indicators. As will be described in greater detail below for FIG. 3, mitigation module 124 also manages has a lifecycle of treats.

FIG. 2 is a diagram illustrating components of a threat detection device in FIG. 1 in greater detail, according to an embodiment. As illustrated in FIG. 2, DNS analysis module 126 includes four submodules. Each of these modules performs analysis surrounding the domain name to assist threat recognition module 122 in determining whether a domain is a potential abuser. For example, using these submodules, DNS analysis module 126 may output a score or other information representing the results of the domain name analysis to threat recognition module 122. Threat recognition module 122 correlates the domain information with the underlying IP transaction data. Based on both the domain name analysis and threat recognition module 122's analysis of the underlying IP transaction data, threat recognition module 122 determines whether the domain, and its associated IP addresses, represents a threat.

DNS analysis module 126's four submodules are: a Whois analysis module 202, a pattern module 204, a prior registration module 206, and a geographic analysis module 208. Each is addressed in turn.

Whois analysis module 202 analyzes a Whois directory entry for the domain name. Whois is a query and response protocol that is widely used for querying databases that store the registered users or assignees of an Internet resource, such as a domain name, an IP address block, or an autonomous system, but is also used for a wider range of other information. Whois analysis module 202 to determine whether the Whois directory entry includes fraudulent information.

The fraudulent information could be, for example, an incorrect address, mismatched city, state/province/countries, or country code. To determine whether the information is fraudulent. Whois analysis module 202 may check to see if it is a valid address, for example a city-state/country or city-state-street that actually exists. The information may also be compared against a phone number. In particular, Whois analysis module 202 may perform a reverse lookup on the phone number to determine an address that the number calls. Then, the address may be compared with the Whois information in the registration information.

Below of is an example Whois registration for the domain name “r6jluq68xj3gy4vq42zl.info.” This may for example be the result of a command line call “whois r6jluq68xj3gy4vq42zl.info.” In different examples, Whois analyzes the entry analysis module 202 may check any of the following fields against a rule for validity:

### Domain Name:R6JLUQ68XJ3GY4VQ42ZL.INFO

### Domain ID: D53036287-LRMS

### Creation Date: 2014-06-26T03:50:32Z

### Updated Date: 2015-02-20T02:58:30Z

### Registry Expiry Date: 2015-06-26T03:50:32Z

Sponsoring Registrar:GMO Internet, Inc. d/b/a Onamae.com (R110-LRMS)

### Sponsoring Registrar IANA ID: 49

### WHOIS Server:

### Referral URL:

Domain Status: ok http://www.icann.org/epp#ok

### Registrant ID:202E55C3705411

Registrant Name: Whois Whois Privacy Protection Service by onamae.com
Registrant Organization:Whois Privacy Protection Service by onamae.com

### Registrant Street: 26-1 Sakuragaoka-cho

### Registrant Street: Cerulean Tower 11F

### Registrant City:Shibuya-ku

### Registrant State/Province:Tokyo

### Registrant Postal Code:150-8512

### Registrant Country:JP

### Registrant Phone:+81.0303648727

### Registrant Phone Ext:

### Registrant Fax:

### Registrant Fax Ext:

Registrant Email:proxy@whoisprotectservice.com

### Admin ID:57B3BE0E926BA6

Admin Name:Whois Whois Privacy Protection Service by onamae.com
Admin Organization: Whois Privacy Protection Service by onamae.com

### Admin Street: 26-1 Sakuragaoka-cho

### Admin Street: Cerulean Tower 11F

### Admin City:Shibuya-ku

### Admin State/Province:Tokyo

### Admin Postal Code:150-8512

### Admin Country:JP

### Admin Phone:+81.0303648727

### Admin Phone Ext:

### Admin Fax:

### Admin Fax Ext:

Admin Email:proxy@whoisprotectservice.com

### Billing ID:57B3B89D085681

Billing Name:Whois Whois Privacy Protection Service by onamae.com
Billing Organization: Whois Privacy Protection Service by onamae.com

### Billing Street: 26-1 Sakuragaoka-cho

### Billing Street: Cerulean Tower 11F

### Billing City:Shibuya-ku

### Billing State/Province:Tokyo

### Billing Postal Code:150-8512

### Billing Country:JP

### Billing Phone:+81.0303648727

### Billing Phone Ext:

### Billing Fax:

### Billing Fax Ext:

Billing Email:proxy@whoisprotectservice.corn

### Tech ID:57B3BE3E60A35B

Tech Name: Whois Whois Privacy Protection Service by onamae.com
Tech Organization:Whois Privacy Protection Service by onamae.com

### Tech Street: 26-1 Sakuragaoka-cho

### Tech Street: Cerulean Tower 11F

### Tech City:Shibuya-ku

### Tech State/Province:Tokyo

### Tech Postal Code:150-8512

### Tech Country:JP

### Tech Phone:+81.0303648727

### Tech Phone Ext:

### Tech Fax:

### Tech Fax Ext:

Tech Email:proxy@whoisprotectservice.com

### Name Server:NS1.FGH65D4RTG5F6F.NET

### Name Server:NS2.FGH65D4RTG5F6F.NETDNSSEC:Unsigned

In addition to checking for fraudulent information, Whois analysis module 202 may also correlate the Whois registration across other domains. For example, if multiple domain entries have the same or similar address they are likely associated with the same entity. If one domain associated with that entity is determined to be a suspected abuser, then other domains associated with that entity may also be suspect.

Pattern module 204 may check to see if other domains exist matching a common pattern. Domains registered automatically for malicious purposes tend to follow a pattern reflected in the malicious code itself. They may be registered in bulk and have a common top-level domain name. Below the top level domain, they may follow a serial pattern within a sliding window. For example, they may have fields that increment or decrement. Three examples are below:

(1) 0xxxyyyzzz.ru 1xxxyyyzzz.ru 2xxxyyyzzz.ru
(2) 0yyyzzzaaa.ru 1yyyzzzaaa.ru 2yyyzzzaaa.ru
(3) 4569.0aa200xx.ro 4569.1 bb200yy.ro 4569.1 cc200yy.ro

To check for the pattern, pattern module 204 may check to see if multiple domains match a common regular expression. In addition to regular expressions, other pattern matching techniques may be used. For example, the attacker may register domain names including a field selected from a database of words, e.g., dog_yyyzzz.ru, cat_yyyzzz.ru, etc. In that example, pattern module 204 may look for correlations among the different domain names.

Thus, pattern module 204 determines that various domain names match a common regular expression or other pattern. Pattern module 204 may identify the domain names as coming from a common source and may flag that common source as a potential abuser.

Prior registration module 206 may check to see whether the domain name was registered in a very recent timeframe. It may be unlikely that a legitimate website or web service starts operations immediately after the domain name is registered. Generally, when a service starts operation very soon after the domain name is registered, the domain name registration occurred automatically by a computing device. That immediate, automatic operation may be indicative of the service being to support an attack.

In addition, prior registration module 206 may check the frequency of alterations to the DNS records, such as the DNS name server (NS) and address (A) records. The name server may indicate an IP address of the DNS server responsible for that domain, and the address records may indicate the IP address associated with that domain. To check the frequency, prior registration module 206 may periodically query the name server and store the historical data and historical DNS database 128. The resource records may also have information on geographic location and Internet service providers. Here is an example of data from a DNS resource record:

0xxxyyyzzz.ru IN NS ns1.freehost.net (Geolocation Netherlands, DNS BGP, Whois)
IN A 31.3.3.7 (Geolocation Costa Rica, BGP, ISP, WHOIS)

In one embodiment, prior registration module 206 may check whether a frequency at which the name server or address record IP addresses change exceeds a threshold. In another embodiment, prior registration module 206 may check whether a frequency at which the name server or address record IP addresses change to different Internet service providers exceeds a threshold. In yet another embodiment, prior registration module 206 may check whether a frequency at which geographic locations associated with the resource records change. To determine the geographic locations associated with the resource records change, prior registration module 206 may access geographic analysis module 208.

In one example, the DNS may have the resource record “www.example.com IN NS 4.2.2.1 and IN A 1.3.3.7” at a first point in time. Then, later, the A record (or NS record) changes and is now part of an IP block being announced out of Romania whereas the first two were out of the US. And still later, the IP address is resolved to a host in Costa Rica, etc. Frequency of NS record changes should be rare. DNS A records can change more frequently, but should not generally frequently varying between different Internet Service Providers across different regions of the globe. If it does, prior registration module 206 may detect a potential threat.

Geographic analysis module 208 assesses a geographic location for a domain. A geolocation may be stored in the resource record, or geographic analysis module 208 may determine it by looking up the IP address in a Whois database or in an IP geolocation database that has a registry of locations associated with IP addresses. Geographic analysis module 208 may compare the geographic location determined by different means. If the geographic regions do not match (e.g., they do not correspond to similar geographic areas), threat detection device 120 may identify the domain as being a potential attacker.

FIG. 3 is a diagram illustrating a threat detection system 300. In an example, the functionality of system 300 in FIG. 3 may be included in threat detection device 120 in FIG. 1. Like threat detection device 120, system 300 includes threat recognition module 122, DNS analysis module 126, and mitigation module 124, which are included in a threat reaction module 330. In addition, threat reaction module 330 includes a source recognition module 322, heuristics 304, threat rules 306, and mitigation rules 308, which are all accessible using an administrative interface module 318. Like in FIG. 1, Each of these components is addressed in turn.

The amount of data collected in the manner described for FIG. 1 can get large quickly. For this reason, aggregation module 310 encodes customer or network environment data so that it requires less space before storing it in network data 302. In one embodiment, aggregation module 310 may aggregate the collected data into counts of requests having common characteristics. For example, if five requests were sent from a particular source address in a day and each request was in a different data flow, the netflow data may have five records: one for each data flow. As described above, each record may include a start and end times (or a duration) of the data flow. Aggregation module 310 may aggregate the five records into one stating that on that day a total of five requests were received from that source address. For application data, aggregation module 310 can aggregate in a similar manner. For example, if a particular source address makes five application calls to create new user accounts, aggregation module 310 may aggregate the five records into one stating that on that day a total of five new user requests were received from that source address.

Threat reaction module 330 detects and responds to these malicious requests. Threat reaction module 330 can, for example, use machine learning techniques to detect and respond to these malicious requests. Example machine learning techniques include decision tree learning, association rule learning, artificial neural networks, inductive logic programming, support vector machines, clustering, Bayesian networks, reinforcement learning, representation learning, similarity and metric learning, and sparse dictionary learning.

Machine learning techniques generally are trained on a set of learned network environment data, external data sources, and, after training, reacts to new data based in accordance. For example, threat reaction module 330 may be trained with a set of known circumstances that are recognized as being a network abuse and may know how to respond in the event those known circumstances occur. In addition, from those circumstances, threat reaction module 330 may generate heuristics and rules that can be used to react to other circumstances.

To detect these types abuses, threat reaction module 330 includes DNS analysis module 126, source recognition module 322, and threat recognition module 122. Source recognition module 322 analyzes the collected data in network data 302 and DNS analysis 126 to compare against heuristics 304. As described above, when a number of domains are determined to correspond to a particular common pattern, such as a regular expression, as specified in heuristics 304, source recognition module may identify the domains, and their corresponding network addresses as belonging to a common abuse entity.

Additionally, when a plurality of the incoming requests is determined to match the heuristic, source recognition module 322 determines that the requests, having the plurality of different sources, are from a common abuse entity. In the example where the respective incoming requests are application calls, the heuristic may be a regular expression rule, or other pattern matching rule, against a field of the application call. In the example where the application call is to create a new user account, the pattern matching rule may be against a requested username. Source recognition module 322 determines whether the application calls match a regular expression or satisfy the pattern matching rule. When the application calls are determined to match a regular expression or satisfy the pattern matching rule, source recognition module 322 determines that the requests, having a plurality of different external source addresses, are from the common abuse entity.

Once identified, source recognition module 322 sends common abuse entities to threat recognition module 122. Common sources may identify a group of IP addresses or application requests belonging to each common request. In addition, as described above for FIG. 2, DNS analysis module 126 may analyze historical DNS Data 128 and real-time DNS transaction data 116 to determine suspiciousness of the domain. The suspiciousness may be represented as one or more scores or simply a report of how the domain faired against the variety of conditions specified in DNS rules 228. That information is also passed to threat recognition module.

Based on the data from DNS analysis module 126 and source recognition module 322, threat recognition module 122 determines whether the common abuse entity is a potential malicious entity of the network environment. For example, threat recognition module 122 may determine a threat level for the entity indicating that entities' suspiciousness. To determine whether the common abuse entity is a potential malicious entity, threat recognition module 122 can use threat rules 306. Threat rules 306 may specify conditions where the threat recognition module 122 identifies a source as a malicious entity. The conditions may be based on a variety of inputs, including a rate, an external threat feed 332, and others.

In the rate-based approach, threat recognition module 122 evaluates the collected data to determine a rate of incoming network and application requests from the common abuse entity. Threat recognition module 122 may determine whether the rate of incoming requests, having a particular type (e.g., network or application layer requests and if application, whether it is HTTP or some other protocol) matches a heuristic. The rate may match a heuristic when it exceeds a threshold specified by the heuristic. The threshold may be a fixed value in threat rules 306 or may be based on prior traffic, such as prior traffic from the source. For example threshold may be a certain number of standard deviations away from rates that were previously measured. And, when the rate of incoming requests is determined to exceed the threshold, threat recognition module 122 determines that the common abuse entity is a potential network malicious entity of the network environment.

Threat rules 306 may also be based on external threat feed 332. Threat recognition module 122 receives, from external threat feed 332, fingerprint data identifying a suspect source address and determines that the common abuse entity is the potential network malicious entity based on whether the suspect source address from the external data feed belongs to the common abuse entity. Fingerprint data may be stored with threat rules 306 for future use. External threat feed may also include reputation data surrounding different source addresses. The poor reputation data may indicate that others have reported bad conduct of the IP address or other network or resource identifier. The external threat feed and historical DNS heuristics may also be used as a feedback mechanism to train new threat rules 306 in threat reaction module 330.

The external threat feed may also include data from news sources (such as a Google News source available from Google Inc. of Mountain View, Calif.) and social media sources (such as a Facebook source available from Facebook, Inc. of Menlo Park, Calif.). For example, an uprising in the Middle East may appear as a spike in traffic from a particular geographic area, which the threat rules would otherwise register as an abuse. But, data from these news or social media sources may indicate that it is not an abuse but a wave of legitimate traffic caused by a real-world event.

Finally, the external threat feed may include real-time DNS transaction data. For example, sources that are requesting similar application or network request transactions may be determined as from a common abuse entity. To determine whether sources are requesting similar application or network transactions, the DNS transaction data may be used.

In addition to evaluating a rate of the requests, threat rules 306 may also look at other past conduct of the source. For example, in the case of application abuse, threat rules 306 may indicate a potential threat when no prior requests are received from the source and now they are calling applications in a regular pattern.

Finally, threat recognition module 122 may look to the number of IP addresses mapped to a particular domain in the Domain Name System, the geographic origination of source IP addresses, or whether any of the incoming requests has used a fraudulent credit card or having been associated with other type of malicious behavior.

To account these different factors—e.g., external threat data, rate changes, geographic originating, prior malicious behavior, threat recognition module 122 may take into account a weighted scoring method to determine whether an abuse is taking place and even to signal a type of mitigation. These factors may each receive a different weight and the weighted values may be combined (e.g., by summing) to determine a score. If the score is above a threshold, the common abuse entity is identified as a potential abuser.

Threat recognition module 122 compares this information or any combination thereof with thresholds and conditions defined in threat rules 306 to determine whether the common abuse entity is a potential malicious entity. Threat recognition module 122 then sends its determination to mitigation module 124.

In addition, threat recognition module 122 may identify targets of the attack. To identify the target, threat recognition module 122 may look to the destination addresses (e.g., IP addresses) of the packets involved in the attack. In addition to identifying these destination addresses as targets of the attack, threat recognition module 122 may also aggregate the addresses into ranges and extrapolate other destinations that may be targeted using the techniques described above for identifying the source common abuse entity.

In response to the determination that the common abuse entity is a potential distributed malicious entity, mitigation module 124 looks to mitigation rules 308 to determine what action, if any, to take. The mitigation rules 308 may specify certain actions to take in depending on characteristics of the threat or the source. The characteristics of the threat can include, for example, whether it is a rate-based abuse, whether it is an application abuse or denial of service abuse and how it was identified by threat recognition module 122 (e.g., by geographic origination, external threat feed, etc.)

When an abuse is detected, mitigation rules 308 can specify mitigation module 124 to take one of several actions based on the characteristics of the abuse. First, mitigation module 124 sends a message to a specialized software mitigation agent or network component, such as a firewall, router, switch, load balancer, DNS server or DDOS mitigation appliance, to block traffic from addresses belonging to the common abuse entity. Blocking traffic may involve using an access control list (ACL), a firewall rule, a policy based routing (PBR) technique, a Border Gate Control FlowSpec modification, a black hole filtering technique, or a DNS blocking technique. Second, mitigation module 124 can inform a DNS BIND Response Policy Zone, e.g., a sink hole, to stop lookups of the DNS hostname or domain considered a threat. Third, mitigation module 124 can send a message to change the resource records to map the domain to another IP address not associated with the attacking entity. The other IP address may be a web page informing of the possible attack in progress. Fourth, mitigation module 124 can send a message to an application component to flag accounts the common abuse entity created to mark the accounts as suspicious. Fifth and finally, mitigation module 124 can send to an operator an alert indicating the potential threat, allowing the operator to decide what, if any, mitigating action to take.

Mitigation module 124 may send the mitigation instruction to a device upstream from the target. To send the instruction upstream, mitigation module 124 may first determine the plurality of targets and determine which device or devices are between the plurality of targets and the plurality of servers that are part of the common source entity perpetrating the attack. The devices mitigation module 124 identifies may be a network Internet Service Provider connecting the attackers and targets. The mitigation instruction may be manual or by an API transaction.

Administrative interface module 318 may enable the operator to take select which mitigating action to take. Administrative interface module 318 may be a web portal, command line interface (CLI) or API interface and also enable an operator to observe network data 302 and to specify heuristics 304, threat rules 306, and mitigation rules 308.

When an operator takes an action on a potential threat, that action can be used as feedback into threat reaction module 330 for training. The feedback may be used to develop new mitigation rules 308. For example, after an operator manually mitigates a threat a certain number of times, a mitigation rule 308 may be created that automatically mitigates the threat. In this way, by allowing feedback and modification of heuristics 304, threat rules 306, and mitigation rules 308, administrative interface module 318 may enable a user to customize the abuse mitigation strategy.

Customizing the abuse mitigation strategy may involve establishing a lifecycle for abuse mitigation. For example, when a threat level for a particular entity increases, indicating that the entity is more suspicious, mitigation rule 308 may indicate that a first mitigation strategy, such as increased monitoring, be deployed. Then, when a threat level for a particular entity increases further, mitigation rule 308 may indicate that a second mitigation strategy be deployed. The second mitigation strategy may be more disruptive to traffic flow in the network than the first mitigation strategy. Changing from a first to a second mitigation strategy may involve sending a mitigation instruction.

Later, the threat level for the entity may be decreased. For example, threat recognition module 122 may get new information from DNS analysis module 126 and source recognition module 322 to make it determine, based on threat rules 306, that the entity is not a threat. In another example, an operator can enter a new rule in threat rules 306 indicating that the entity is not a threat. In either case, threat recognition module 122 sends a message to mitigation module 124 indicating that the entity's threat level has decreased. On receipt of the message, mitigation module 124, in accordance with mitigation rules 308, may remove a mitigation strategy for the entity. Removing the mitigation strategy may involve sending a mitigation instruction.

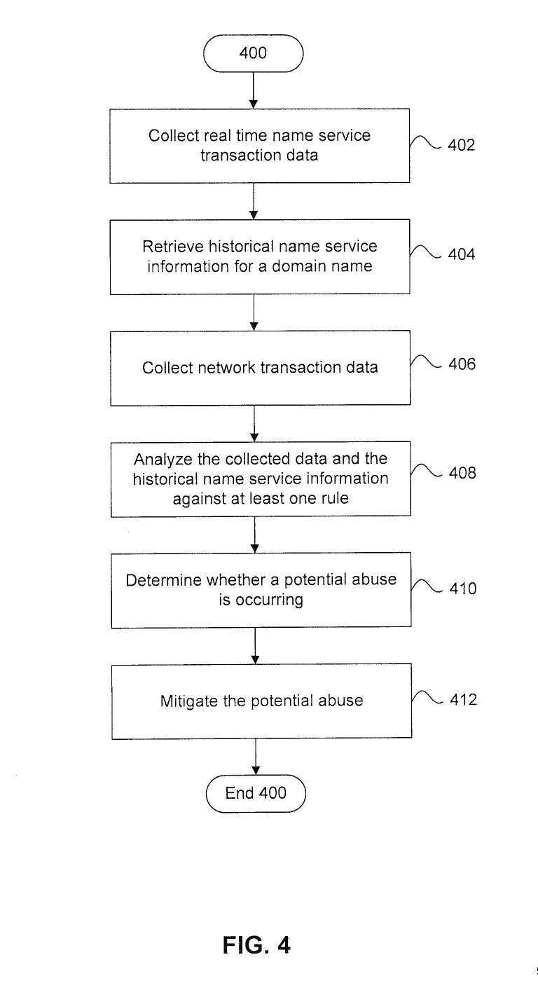

FIG. 4 is a flowchart illustrating a method 400 for abuse detection, according to an embodiment. Method 400 may be used in operation of the systems in FIG. 1-3 and the discussion the operations of those systems is incorporated into the discussion below.

Method 400 begins at step 402 when real-time name service transaction data is collected. The real-time name service transaction data may be transmitted to resolve a domain name to a network address and may be collected from the network environment.

At step 404, historical name service information for the domain name is retrieved. The historical information may include a time value indicating how long ago the network address was registered to the domain name.

At step 406, information on data sent between the network environment and the network address is collected. The data may be netflow, PCAP, or application-level data.

At step 408, the collected data and the historical name service information are analyzed against at least one rule. The analysis may include, for example: (i) determining whether the other domain names match a common pattern; (ii) comparing a geographic location associated with a name server record for the domain name with a geographic location associated with an address record for the network address; (iii) determining whether a frequency at which a name server, address, Internet Service Provider or geographic location record for the domain name changes exceeds a threshold; or (iv) analyzing a whois directory entry for the domain name to determine whether the whois directory entry includes fraudulent information.

At step 410, when the collected data and the historical name service information are determined to match at least one rule, the network address that is determined to be associated with a potential abuser of the network environment. This determination may be made based at least in part on whether: (i) the other domain names match the common pattern; (ii) the geographic locations associated with the name server and address records are determined to be different; (iii) the change frequency in step 410 is determined to exceed the threshold; and (iv) whois directory entry is determined to include fraudulent information

Finally at step 412, in response to the determination that the network address is associated with a potential abuser of the network environment, a mitigation instruction is sent to disrupt communications between the network environment and the network address

### Conclusion

Each of the devices and modules in FIGS. 1-3 may be implemented in hardware, software, firmware, or any combination thereof.

Each of the devices and modules in FIGS. 1-3 may be implemented on the same or different computing devices. Such computing devices can include, but are not limited to, a personal computer, a mobile device such as a mobile phone tablet device or laptop device, workstation, embedded system, game console, television, set-top box, or any other computing device. Further, a computing device can include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, a memory, and a graphical user interface display. The computing device may also have multiple processors and multiple shared or separate memory components. For example, the computing device may be a part of or the entirety of a clustered or distributed computing environment or server farm.

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for detecting an abuse to a network environment, comprising:
(a) collecting real-time name service transaction data from the network environment, the transaction data to resolve a domain name to a network address;
(b) retrieving historical and current name service information for the domain name or the network address;
(c) collecting transaction information on data sent between the network environment and the network address;
(d) analyzing the collected transaction information and the historical name service information against at least one rule; and
(e) when the collected transaction information and the historical name service information are determined to match at least one rule, determining that the network address is associated with a potential abuser of the network environment.

2. The method of claim 1, wherein the analyzing (d) comprises determining a time value indicating how long ago, according to the historical name service information, the network address was registered to the domain name, and
wherein the determining (e) comprises determining that the network address is associated with a potential abuser of the network environment based at least in part on the determined time value.

3. The method of claim 1, wherein the retrieving (b) comprises retrieving other domain names identifying the network address, and
wherein the analyzing (d) comprises determining whether the other domain names match a common pattern,
wherein the determining (e) comprises determining that the network address is associated with a potential abuser of the network environment based at least in part on the whether the other domain names match the common pattern.

4. The method of claim 3, wherein the common pattern is a regular expression or other identifiable pattern.

5. The method of claim 1, wherein the analyzing (d) comprises comparing a geographic location associated with a name server record for the domain name with a geographic location associated with an address record for the network address;
wherein the determining (e) comprises determining that the network address is associated with a potential abuser of the network environment based at least in part on the whether the geographic locations associated with the name server and address records are determined to be different.

6. The method of claim 1, wherein the analyzing (d) comprises determining whether a frequency at which a name server record for the domain name changes exceeds a threshold, and
wherein the determining (e) comprises determining that the network address is associated with a potential abuser of the network environment based at least in part on the whether the frequency is determined to exceed the threshold.

7. The method of claim 1, wherein the analyzing (d) comprises determining whether a frequency at which an address record for the network address changes exceeds a threshold, and
wherein the determining (e) comprises determining that the network address is associated with a potential abuser of the network environment based at least in part on the whether the frequency is determined to exceed the threshold.

8. The method of claim 1, wherein the analyzing (d) comprises determining whether a frequency at which an Internet service provider for the network address changes exceeds a threshold, and
wherein the determining (e) comprises determining that the network address is associated with a potential abuser of the network environment based at least in part on the whether the frequency is determined to exceed the threshold.

9. The method of claim 1, wherein the analyzing (d) comprises determining whether a frequency at which a geographic location for the network address changes exceeds a threshold, and
wherein the determining (e) comprises determining that the network address is associated with a potential abuser of the network environment based at least in part on the whether the frequency is determined to exceed the threshold.

10. The method of claim 1, wherein the analyzing (d) comprises analyzing a whois directory entry for the domain name to determine whether the whois directory entry includes fraudulent information, and
wherein the determining (e) comprises determining that the network address is associated with a potential abuser of the network environment based at least in part on the whether whois directory entry is determined to include fraudulent information.

11. The method of claim 1, further comprising:
(e) in response to the determination that the network address is associated with a potential abuser of the network environment, sending a mitigation instruction to disrupt communications between the network environment and the network address.

12. A system for detecting an abuse to a network environment, comprising:
a threat detection device that collects real-time name service transaction data from the network environment, the transaction data to resolve a domain name to a network address, and collects transaction information on data sent between the network environment and the network address;
a DNS analysis module that retrieves historical and current name service information for the domain name and the network address and analyzes the collected transaction information and the historical name service information against at least one rule; and
a threat recognition module that, when the collected transaction information and the historical name service information are determined to match at least one rule, determines that the network address is associated with a potential abuser of the network environment.

13. The system of claim 12, wherein the DNS analysis module includes a prior registration module that determines a time value indicating how long ago, according to the historical name service information, the network address was registered to the domain name, and
wherein the threat recognition module determines that the network address is associated with a potential abuser of the network environment based at least in part on the determined time value.

14. The system of claim 12, wherein the threat detection device retrieves other domain names identifying the network address,
wherein the DNS analysis module includes a regular expression module that determines whether the other domain names match a common regular expression or other identifiable pattern, and
wherein the threat recognition module determines that the network address is associated with a potential abuser of the network environment based at least in part on the whether the other domain names match the common regular expression.

15. The system of claim 12, wherein the threat detection device retrieves other domain names registered at a domain name server of the domain name,
wherein the DNS analysis module includes a regular expression module that determines whether the other domain names match a common pattern, and
wherein the threat recognition module determines that the network address is associated with a potential abuser of the network environment based at least in part on the whether the other domain names match the common pattern.

16. The system of claim 12, wherein the DNS analysis module includes a geographic analysis module that compares a geographic location associated with a name server record for the domain name with a geographic location associated with an address record for the network address,
wherein the threat recognition module determines that the network address is associated with a potential abuser of the network environment based at least in part on the whether the geographic locations associated with the name server and address records are determined to be different.

17. The system of claim 12, wherein the DNS analysis module includes a prior registration module that determines whether a frequency at which a name server record for the domain name changes exceeds a threshold, and
wherein the threat recognition module determines that the network address is associated with a potential abuser of the network environment based at least in part on the whether the frequency is determined to exceed the threshold.

18. The system of claim 12, wherein the DNS analysis module includes a prior registration module that determines whether a frequency at which an address record for the network address changes exceeds a threshold, and
wherein the threat recognition module determines that the network address is associated with a potential abuser of the network environment based at least in part on the whether the frequency is determined to exceed the threshold.

19. The system of claim 12, wherein the DNS analysis module includes a prior registration module that determines whether a frequency at which an Internet service provider for the network address changes exceeds a threshold, and
wherein the threat recognition module determines that the network address is associated with a potential abuser of the network environment based at least in part on the whether the frequency is determined to exceed the threshold.

20. The system of claim 12, wherein the DNS analysis module includes a prior registration module that determines whether a frequency at which a geographic location for the network address changes is determined to exceed a threshold, and
wherein the threat recognition module determines that the network address is associated with a potential abuser of the network environment based at least in part on the whether the frequency is determined to exceed the threshold.

21. The system of claim 12, wherein the DNS analysis module includes a whois analysis module that analyzes a whois directory entry for the domain name to determine whether the whois directory entry includes fraudulent information, and
wherein the threat recognition module determines that the network address is associated with a potential abuser of the network environment based at least in part on the whether whois directory entry is determined to include fraudulent information.

22. The system of claim 12, further comprising:
a mitigation module that, in response to the determination that the network address is associated with a potential abuser of the network environment, sends a mitigation instruction to disrupt communications between the network environment and the network address.

23. A computer-implemented method for detecting an abuse to a network environment, comprising:
(a) collecting real-time name service transaction data from the network environment, the transaction data to resolve a domain name to a network address;
(b) retrieving historical and current name service information for the domain name or the network address;
(c) collecting transaction information on data sent between the network environment and the network address;
(d) analyzing the collected transaction information and the historical name service information against at least one rule; and
(e) when the collected transaction information and the historical name service information are determined to match at least one rule, determining that the network address is associated with a potential abuser of the network environment.
